(19) United States
(12) Patent Application Publication
(10) Pub. No.: US 2010/0006720 A1
(43) Pub. Date: Jan. 14, 2010

(54) Connection device for connecting bag to bicycle saddle

(76) Inventor: Lien Chien-Ping, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/216,840

(22) Filed: Jul. 11, 2008

(51) Int. Cl. B62J 7/02

(52) U.S. Cl. 248/201

(57) ABSTRACT

A connection device for connecting a bag to a bicycle saddle a first connection unit connected between the saddle frame and the top of the bag, and a second connection unit which is connected between the seat post and the rear end of the bag. The second connection unit uses a clip member to clip on the seat post. The first connection unit includes a first portion connected to the saddle frame and a second portion pivotably connected between the first portion and the bag which can be pivoted upward when the second connection unit is disengaged from the seat post, and the angular position for the bag can be set as needed.

### FIELD OF THE INVENTION

The present invention relates to a connection device for connecting a bag to a bicycle saddle.

### BACKGROUND OF THE INVENTION

A conventional connection device for connecting a bag to a bicycle saddle generally includes two rubber strips fixed to the top of the bag and go through spaces in the saddle frames. Two sides of the bag include a hooking unit which is located on two ends of the rubber strips. Each rubber strip includes holes with which the hooking unit is hooked. The bag further includes another hooking unit that includes hook ends so as to be hooked to the seat post.

Another conventional connection device for connecting a bag to a bicycle saddle includes a clamp board which is fixed to a T-shaped frame so as to form an I-shaped clamp slot with which the saddle frame is securely clamped. The T-shaped frame has two rubber rings on two ends of the level rod thereof so as to clamp the connection unit to prevent the connection unit from shaking. A press board is located to face the clamp board and the bag is located between the two boards by screws. When in use, the T-shaped frame together with the bag are positioned between the two transverse rods of the saddle frame and then rotated 90 degrees upward to hook it at position.

However, the two bags are located below the saddle so that when the user wants to pick tools in the bag, he or she has to bend his/her body to check the inside of the bag. Besides, the flip cover of each of the bags is located on one side thereof so that the tools in the bag can easily fall from the opening.

The present invention intends to provide a connection device for connecting a bag to a bicycle saddle wherein the bag is allow to be pivoted upward an angle by pressing the flexible plate of the connection device so that the user can easily see what in the bag and the items in the bag do not drop from the bag.

### SUMMARY OF THE INVENTION

The present invention relates to a connection device for connecting a bag to a saddle and the connection device comprises a first connection unit connected to the saddle frame and comprises a first portion and a second portion which is fixed on a top of the bag. The first portion comprises a first plate, a second plate and a hook part whose first end is connected with the first and second plates. A second end of the hook part has a rotatable hook. The first and second plates clamp the saddle frame. The second connection unit comprises a clip member, a mediate member and a base plate, wherein the mediate member and the base plate are connected to a rear end of the bag. The clip member has one end inserted into the mediate member and the other end of the clip member is connected to a seat post.

The primary object of the present invention is to provide a connection device for connecting a bag to a bicycle saddle, the connection device allows the user to pivot the bag upward to take tools in the bag.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show a bag is connected to the bicycle saddle by the connection device of the present invention;

FIG. 2 shows the first and second portions of the first connection unit on the bag;

FIG. 3 is an exploded view to show the first and second connection units of the present invention and the bag;

FIG. 4 is an exploded view to show the first connection portion of the present invention;

FIG. 5 is an exploded view to show the first connection portion of the present invention from another angle;

FIG. 6 shows a partial cross sectional view taken along line A-A in FIG. 1;

FIG. 7 is a cross sectional view taken along line B-B in FIG. 6;

FIG. 8 shows that the bag is connected to the saddle and not yet connected to the seat post;

FIG. 9 shows a cross sectional view taken along line C-C in FIG. 8;

FIG. 10 shows a cross sectional view taken along lines D-D and E-E in FIG. 9, and

FIG. 11 shows a cross sectional view taken along lines F-F and G-G in FIG. 9.

### DETAILED DESCRIPTION OF THE PREFERRED EMBODIMENT

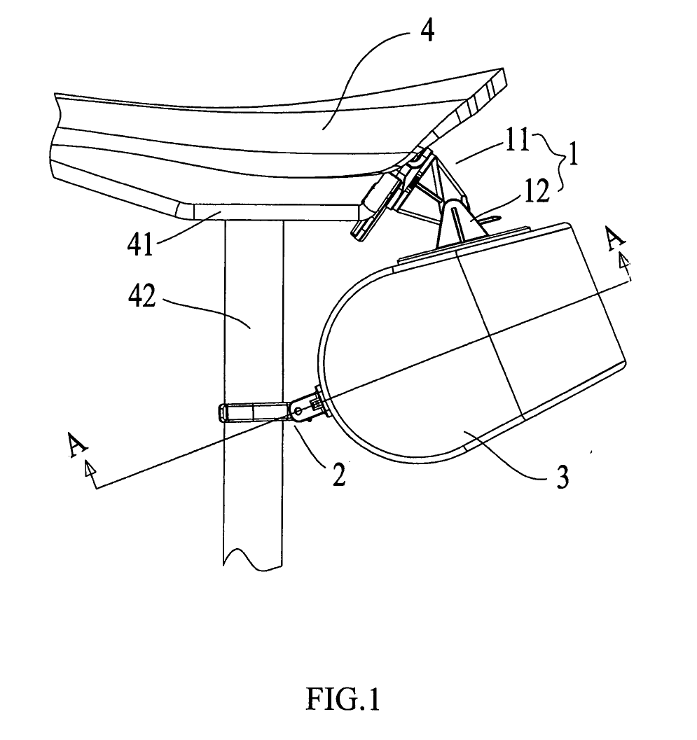

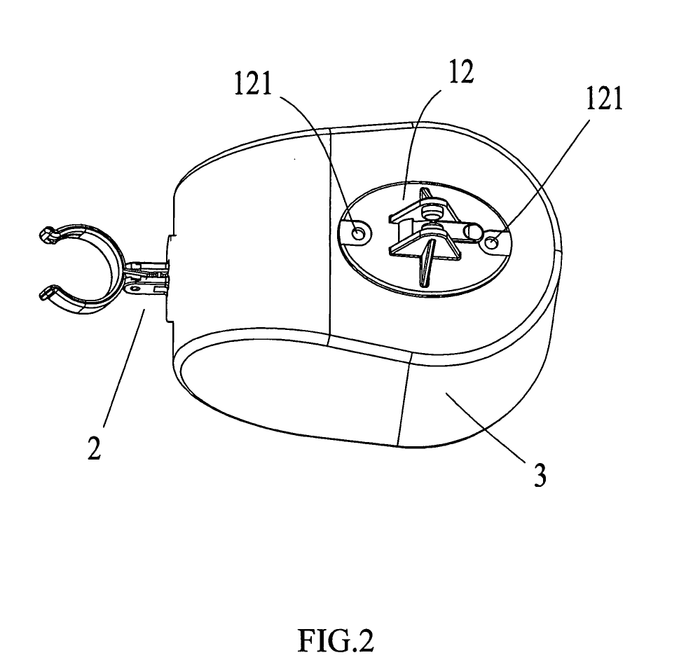

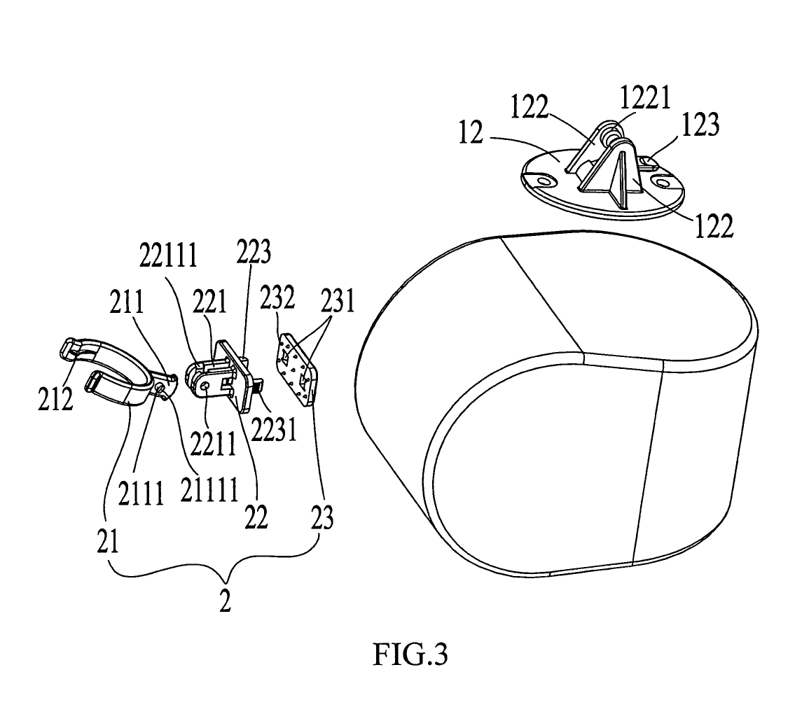

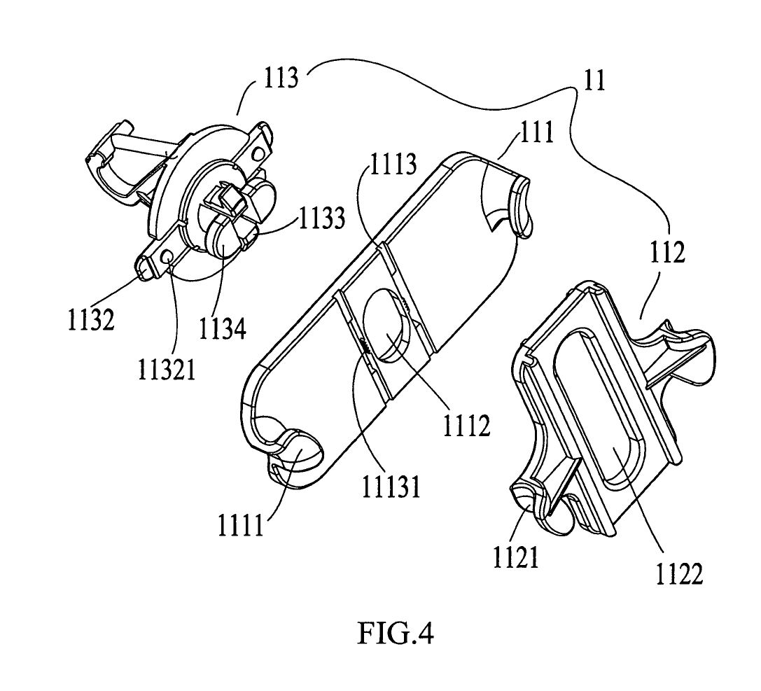

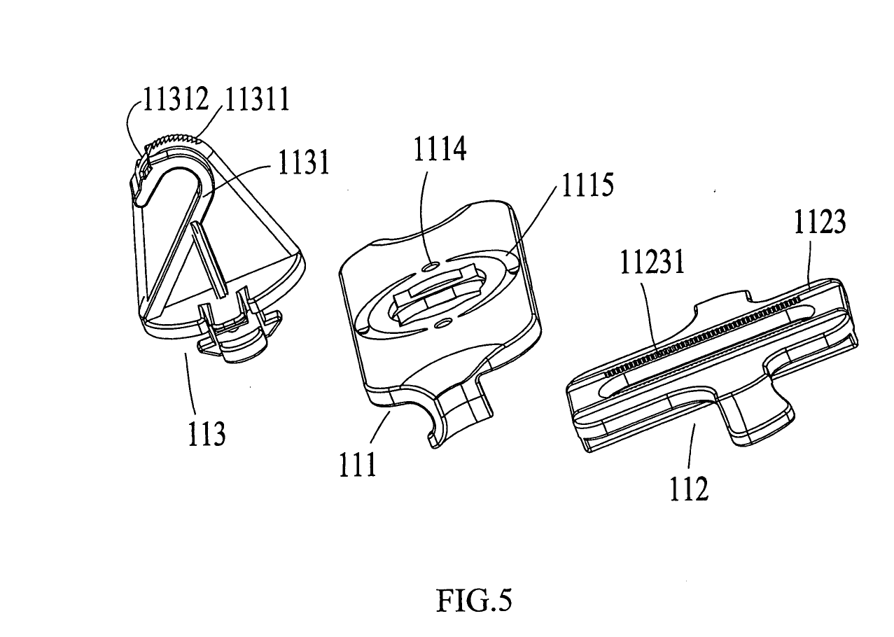

Referring to FIGS. 1-5, the bag 3 is connected to the saddle frame 41 of a bicycle saddle 4 and the seat post 42 by the connection device of the present invention. The connection device comprises a first connection unit 1 connected to the saddle frame 41 and a second connection unit 2 connected to the seat post 42. The first connection unit 1 comprises a first portion 11 and a second portion 12 which is fixed on a top of the bag 3 by rivets via rivet holes 121 defined through the second portion 12. The first portion 11 comprises a first plate 111, a second plate 112 and a hook part 113 whose first end is connected with the first and second plates 111, 112. The first and second plates 111, 112 clamp the saddle frame 41. A second end of the hook part 113 has a hook 1131 which is pivotably connected to the hook part 113.

The first plate 111 includes two first lugs 1111 on two sides thereof and a through hole 1112 is defined through a center of the first plate 111. Two guide slots 1113 are defined in a first surface thereof and each guide slot 1113 has teeth 11131 located therein. The second plate 112 includes two second lugs 1121 on two sides thereof and an elongate slot 1122 is defined through a central portion of the second plate 112. The first and second lugs 1111, 1121 clamp the saddle frame 41 therebetween and the distance between the first and second lugs 1111, 1121 can be adjusted to match with the saddle frames 41 of different brands and inclination, Two rails 1123 extend from a first surface of the second plate 112 and each rail 1123 has teeth 11231 extending from an inside thereof. The hook part 113 includes two first hooking members 1133 and two second hooking members 1134 on the first end thereof. The rails 1123 can be engaged with the guide slots 1113. The second hooking members 1134 extend through the through hole 1112 and engaged with the guide slots 1113 such that the teeth 11231 on the rails 1123 are engaged with the teeth of the guide slots 1113 to position the first plate 111 relative to the second plate 112. When rotating the bag 3 to let the first hooking members 1133 engage the guide slots 1113 via the through hole 1112, the teeth 11131 in the guide slots 1113 are not engaged with the teeth 11231 of the rails 1123. The rails 1123 are movable in the guide slots 1113 so as to adjust the first plate 111 relative to the second plate 112 and a distance between the first lugs 1111 and the second lugs 1121.

The hook part 113 includes a flexible plate 1132 on the first end thereof and a positioning protrusion 11321 extends from the flexible plate 1132. The first plate 111 includes an annular adjustment groove 1115 and positioning holes 1114 defined in a second surface thereof. The first and second hooking members 1133, 1134 extend through the through hole 1112 in the first plate 111 and the elongate slot 1122 of the second plate 112 to connect the first and the second plates 111, 112 together. When rotating the hook part 113, the positioning protrusion 11321 is movable in the adjustment groove 1115 and engaged with one of the positioning holes 1114 when the first and second hooking members 1133, 1134 are in alignment with the guide slots 1113.

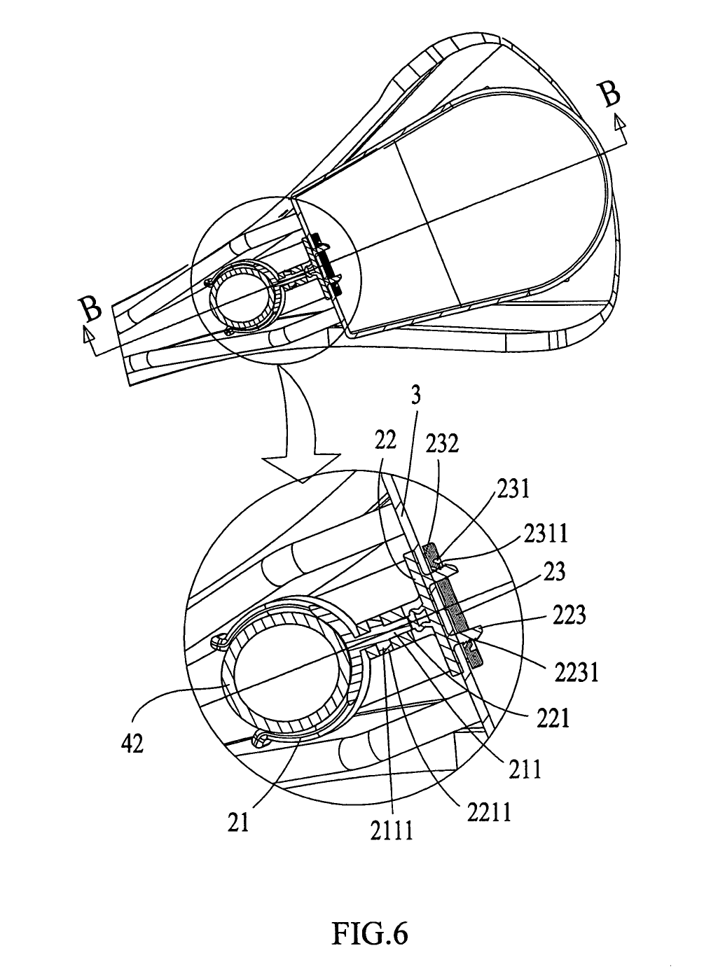

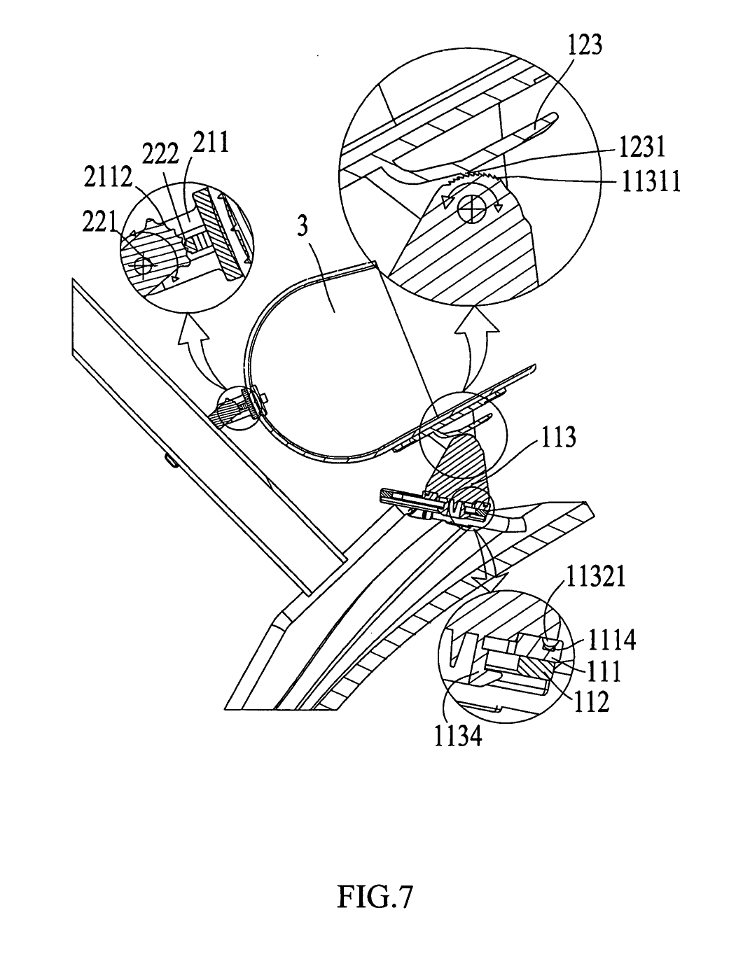

Referring to FIGS. 6 and 7, the second connection unit 2 comprises a clip member 21, a mediate member 22 and a base plate 23. The mediate member 22 and the base plate 23 are connected to a rear end of the bag 3 and the clip member 21 has one end inserted into the mediate member 22 and the other end of the clip member 21 is connected to the seat post 42. The clip member 21 includes grabbing ridges 212 extending from the inside thereof so as to clamp the seat post 42.

The second portion 12 includes two support plates 122 and two pivot supports 1221 extend from the two support plates 122 respectively. A flexible plate 123 is located between the two support plates 122 and includes ratchet teeth 1231 and ribs 1232. The hook part 113 has a hook 1131 which has ratchet teeth 11311 and an engaging slot 11312. The two pivot supports 1221 are located on two sides of the hook 1131 and the ratchet teeth 1231 on the flexible plate 123 are engaged with the ratchet teeth 11311 on the hook 1131 such that the second portion 12 and the hook part 113 are pivotable about the two pivot supports 1221. The rib 1232 is engaged with the engaging slot 11312 when the bag 3 is rotated to face upward.

The mediate member 22 includes a space 221 defined by two projection plates and each projection plate has a pivot hole 2211. Each pivot hole 2211 communicates with a communication slot 22111. The space 221 includes second adjustment teeth 222 defined therein. The mediate member 22 includes two stubs 223 on two sides thereof and teeth 2231 are defined in each of the two stubs 223. The clip member 21 includes an insertion 211 which has pivots 2111 and first adjustment teeth 2112, the pivots 2111 each have an inclined surface 21111. The base plate 23 includes anti-slip tips 232 and two engaging holes 231 are defined through the base plate 23. Each engaging hole 231 includes teeth 2311 defined therein. The stubs 223 extend through the bag 3 and the two engaging holes 231 of the base plate 23. The teeth 2311 in the engaging holes 231 are engaged with the teeth 2231 of the stubs 223. The stubs 223 are engaged with the space 221 and the pivots 2111 are engaged with the pivot holes 2211. The first adjustment teeth 2112 and the second adjustment teeth 222 are engaged with each other so as to adjust the clip member 21 relative to the mediate member 22.

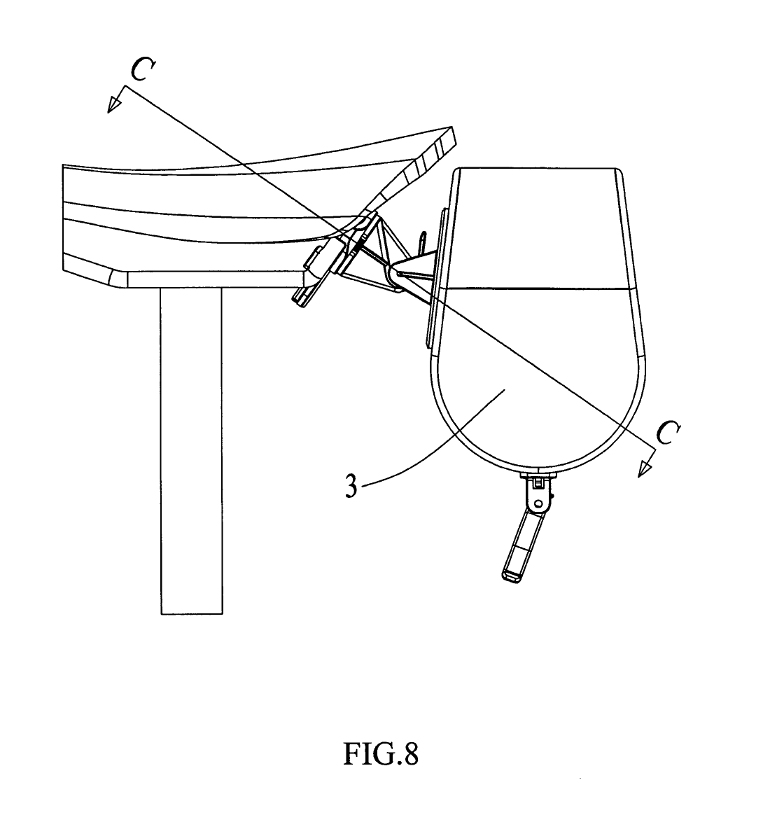

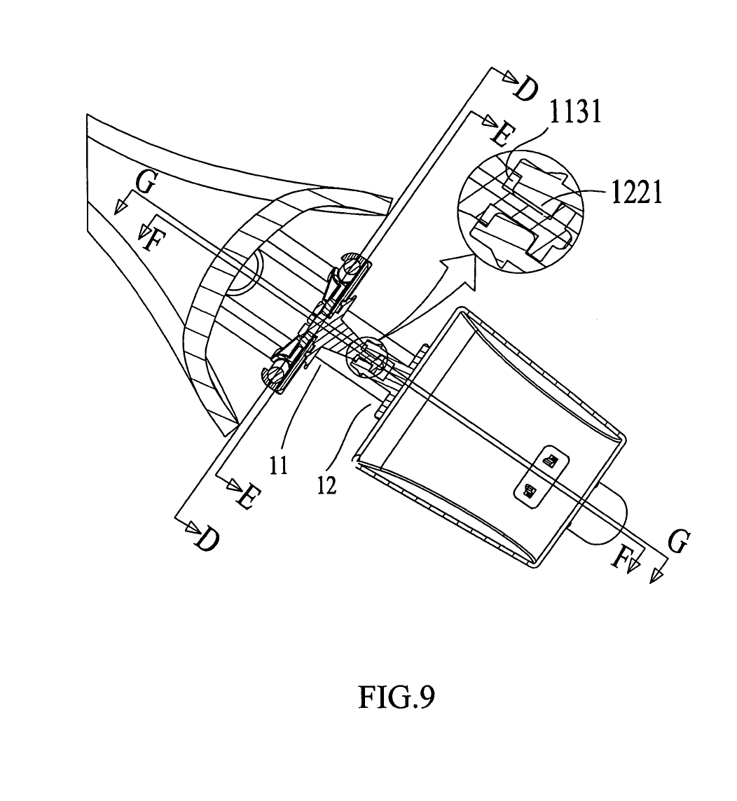

As shown in FIG. 8, the bag 3 can be pivoted upward to let the opening face the user so that the user does not need to bend to see the items received in the bag 3. As shown in FIG. 9, by engaging the pivot supports 1221 with the hook 1131, the first and second portions 11, 12 are connected with each other.

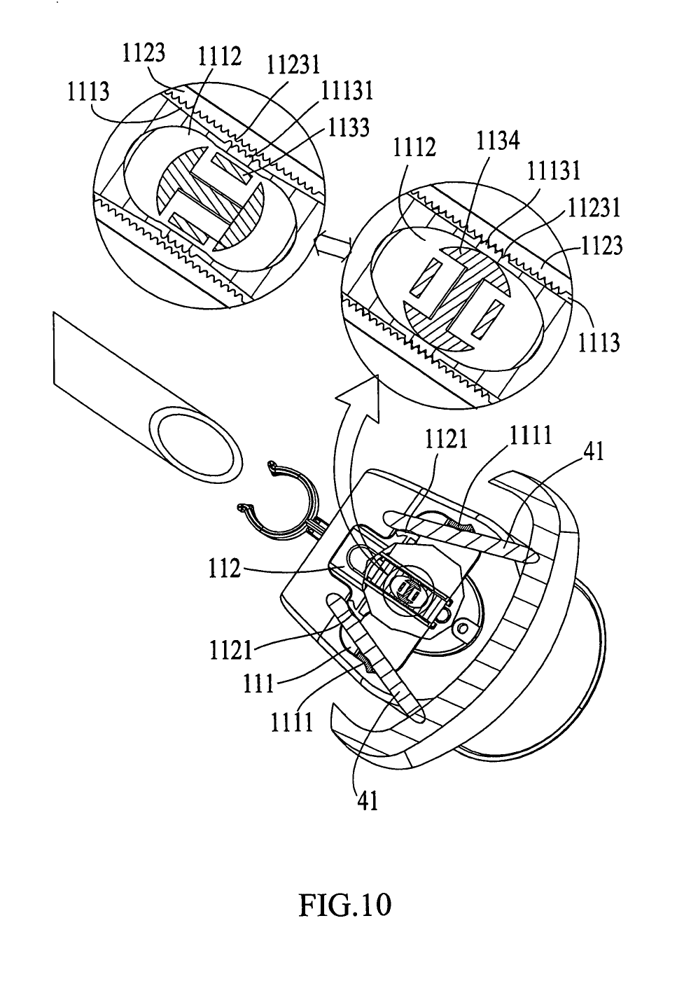

As shown in FIG. 10, the first and second lugs 1111, 1121 clamp the saddle frame 41 and the rails 1123 are engaged with the guide slots 1113. The second hooking members 1134 extend through the through hole 1112 and engage with the guide slots 1113 to engage the teeth 11131 with the teeth 11231 and to restrict that the rails 1123 are movable within the guide slots 1113. By this way, the relative position between the first and second plates 111, 112 can be set. When switching to let the first hooking member 1133 extend through the through hole 1112 and engage with the guide slots 1113, the teeth 11131 with the teeth 11231 are not engaged with each other so that the rails 1123 are movable in the guide slots 1113 such that the relative position between the first and second plates 111,112 can be adjusted. The distance between the first and second lugs 1111, 1121 are adjusted to meet requirement of the saddle frame 41 of different inclination.

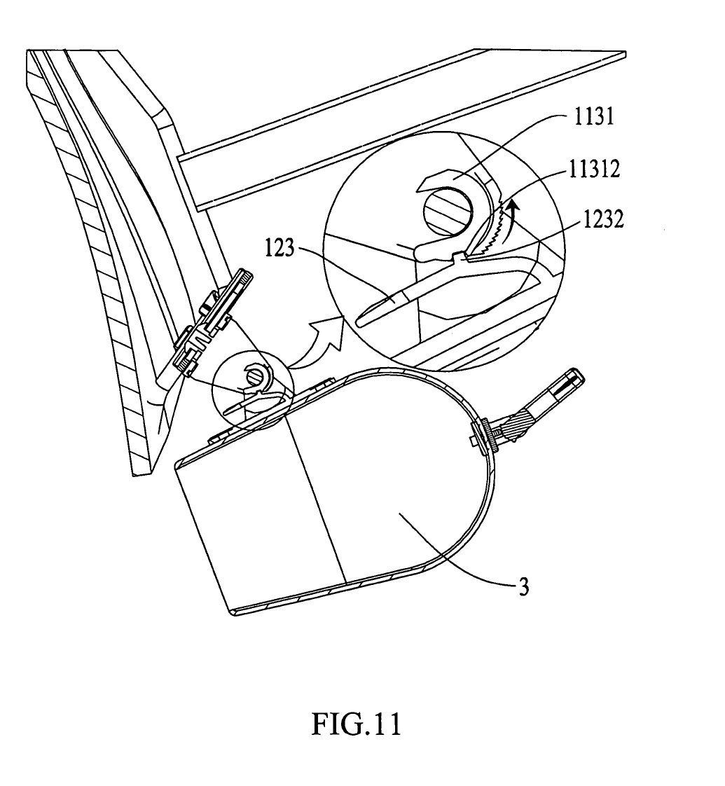

As shown in FIG. 11, when the bag 3 is pivoted upward, the rib 1232 is engaged with the engaging slot 11312 to prevent the bag 3 from overly rotated so that the user can use the bag 3 conveniently. When pressing the flexible plate 123, the rib 1232 is disengaged from the engaging slot 11312, so that the bag 3 can be rotated back again.

While we have shown and described the embodiment in accordance with the present invention, it should be clear to those skilled in the art that further embodiments may be made without departing from the scope of the present invention.

What is claimed is:

1. A connection device for connecting a bag (3) to a saddle (4) which includes a saddle frame (41), the connection device comprising:
a first connection unit (1) adapted to be connected to the saddle frame (41) and comprising a first portion (11) and a second portion (12) which is adapted to be fixed on a top of the bag (3), the first portion (11) comprising a first plate (111, a second plate (112) and a hook part (113) whose first end is connected with the first and second plates (111, 112), the first and second plates (111, 112) adapted to clamp the saddle frame (41), a second end of the hook part (113) having a hook (1131) which is pivotably connected to the hook part (113), and
the second connection unit (2 comprising a clip member (21), a mediate member (22) and a base plate (23), the mediate member (22) and the base plate (23) adapted to be connected to a rear end of the bag (3), the clip member (21) having one end inserted into the mediate member (22) and the other end of the clip member (21) adapted to be connected to a seat post (42).

2. The connection device as claimed in claim 1, wherein the first plate (111) includes two first lugs (1111) on two sides thereof and a through hole (1112) is defined through a center of the first plate (111), two guide slots (1113) are defined in a first surface thereof and each guide slot (1113) has teeth (11131) located therein, the second plate (112) includes two second lugs (1121) on two sides thereof and an elongate slot (1122) is defined through a central portion of the second plate (112), the first and second lugs (1111, 1121) are adapted to clamp the saddle frame (41) therebetween, two rails (1123) extend from a first surface of the second plate (112) and each rail (1123) has teeth (11231) extending from an inside thereof, the hook part (113) includes two first hooking members (1133) and two second hooking members (1134) on the first end thereof, the rails (1123) are engaged with the guide slots (1113), the second hooking members (1134) extend through the through hole (1112) and engaged with the guide slots (1113) such that the teeth (11231) on the rails (1123) are engaged with the teeth of the guide slots (1113) to position the first plate (111) relative to the second plate (112), when rotating the bag (3) to let the first hooking members (1133) engaging the guide slots (1113) via the through hole (1112), the teeth (11131) in the guide slots (1113) are not engaged with the teeth (11231) of the rails (1123), the rails (1123) are movable in the guide slots (1113) so as to adjust the first plate (111) relative to the second plate (112) and a distance between the first lugs (1111) and the second lugs (1121).

3. The connection device as claimed in claim 2, wherein the hook part (113) includes a flexible plate (1132) on the first end thereof and a positioning protrusion (11321) extends from the flexible plate (1132), the first plate (111) includes an annular adjustment groove (1115) and positioning holes (1114) defined in a second surface thereof, the first and second hooking members (1133, 1134) extend through the through hole (1112) in the first plate (111) and the elongate slot (1122) of the second plate (112) to connect the first and the second plates (111, 112) together, when rotating the hook part (113), the positioning protrusion (11321) is movable in the adjustment groove (1115) and engaged with one of the positioning holes (1114) when the first and second hooking members (1133, 1134) are in alignment with the guide slots (1113).

4. The connection device as claimed in claim 1, wherein the second portion (12) includes two support plates (122) and two pivot supports (1221) extend from the two support plates (122) respectively, a flexible plate (123) is located between the two support plates (122) and includes ratchet teeth (1231) and ribs (1232), the hook part (113) has a hook (1131) which has ratchet teeth (11311) and an engaging slot (11312), the two pivot supports (1221) are located on two sides of the hook (1131) and the ratchet teeth (1231) on the flexible plate (123) are engaged with the ratchet teeth (11311) on the hook (1131) such that the second portion (12) and the hook part (113) are pivotable about the two pivot supports (1221), the rib (1232) is engaged with the engaging slot (11312) when the bag (3) is rotated to face upward.

5. The connection device as claimed in claim 1, wherein the mediate member (22) includes a space (221) defined by two projection plates and each projection plate has a pivot hole (2211), each pivot hole (2211) communicates with a communication slot (22111), the space (221) includes second adjustment teeth (222) defined therein, the mediate member (22) includes two stubs (223) on two sides thereof and teeth (2231) are defined in each of the two stubs (223), the clip member (21) includes an insertion (211) which has first adjustment teeth (2112) and the pivots (2111), each pivot (2111) have an inclined surface (21111), the base plate (23) includes anti-slip tips (232) and two engaging holes (231) are defined through the base plate (23), each engaging hole (231) includes teeth (2311) defined therein, the stubs (223) adapted to extend through the bag (3) and extend through the two engaging holes (231) of the base plate (23), the teeth (2311) in the engaging holes (231) are engaged with the teeth (2231) of the stubs (223), the stubs (223) are engaged with the space (221) and the pivots (2111) are engaged with the pivot holes (2211), the first adjustment teeth (1221) and the second adjustment teeth (222) are engaged with each other so as to adjust the clip member (21) relative to the mediate member (22).
